(19) United States
(12) Patent Application Publication
(10) Pub. No.: US 2016/0018535 A1
(43) Pub. Date: Jan. 21, 2016

(54) RADIATION DETECTOR

(71) Applicant: VIEWORKS CO., LTD., Gyeonggi-do (KR)

(72) Inventors: Denny Lap Yen LEE, West Chester, PA (US); Hyun Suk JANG, Gyeonggi-do (KR)

(21) Appl. No.: 14/797,826

(22) Filed: Jul. 13, 2015

Related U.S. Application Data
(60) Provisional application No. 62/024,779, filed on Jul. 15, 2014.

(51) Int. Cl. G01T 1/20

(52) U.S. Cl. CPC G01T 1/2018

(57) ABSTRACT

The present invention relates to a radiation detector including a scintillator configured to emit light based on absorption of radiation, and a light detection unit configured to detect the light emitted from the scintillator. The light detection unit includes a top electrode, a plurality of n-type doped layers, a first intrinsic layer, a p-type doped layer, and a lower electrode.

### CROSS-REFERENCE TO RELATED APPLICATION

This application claims the benefit of U.S. Provisional Application Ser. No. 62/024,779, filed Jul. 15, 2014, the disclosure of which is hereby incorporated by reference in its entirety.

### BACKGROUND OF THE INVENTION

1. Field of the Invention

The present invention relates to a radiation detector, and more particularly, to a radiation detector which is capable of increasing the amount of charges obtained from each incident radiation photon, thereby increasing the signal to noise ratio of the radiation detector.

2. Discussion of Related Art

In recent years, FPXDs (Flat Panel X-ray Detectors) have been developed and widely used in the fields of medical and industrial imaging.

In a method known as the indirect conversion method, a thin layer of an x-ray absorbing scintillation material is used to first convert the absorbed x-ray energy into visible light photons, and a two dimensional pixel arrays of photo-detectors in close contact with the scintillation material is then used to convert the light photons into electrical charges.

Typically, one semiconductor photodiode is used in each pixel for the light to charge conversion.

The conversion efficiency, known as the quantum efficiency, is mostly less than 1 for PN, P-I-N, NP, or N-I-P amorphous silicon photodiodes. This is to say that charges of no more than one electron-hole pair can be collected from each x-ray generated light photon.

Since the charge integration amplifiers for reading out the pixel charges typically have a basic thermal noise of several hundred electrons, the sensitivity, or the signal to noise ratio of such an x-ray image detector is limited by the number of photons collected from each pixel and the number of thermal noise electrons of the charge amplifier.

For low x-ray dose imaging, or low x-ray energy imaging, it is therefore desirable that more charges be obtained from each absorbed light photon.

### SUMMARY OF THE INVENTION

One aspect of the present invention provides a radiation detector including: a scintillator to emit light upon absorption of radiation; and a light detection unit, wherein the light detection unit comprises an top electrode, a plurality of n-type doped layers, a first intrinsic layer, a p-type doped layer, and a lower electrode.

In an embodiment, the plurality of n-type doped layers may include a first n-type doped layer and a second n-type doped layer, the first n-type doped layer may be formed between the top electrode and the first intrinsic layer, and the second n-type doped layer may be formed between the p-type doped layer and the lower electrode.

In an embodiment, the second n-type doped layer may be an n-plus-type doped layer.

In an embodiment, the top electrode, the plurality of n-type doped layers, the first intrinsic layer, the p-type doped layer, and the lower electrode may be layered in a sequence of the lower electrode, the second n-type doped layer, the p-type doped layer, the intrinsic layer, the first n-type doped layer, and the top electrode on the substrate.

In an embodiment, the radiation detector may further include a second intrinsic layer formed between the p-type doped layer and the second n-type doped layer.

In an embodiment, the top electrode may be formed to include Indium Tin Oxide (ITO).

In an embodiment, the radiation detector may further include a voltage supply unit configured to supply a bias voltage needed for an operation of the light detection unit.

In an embodiment, the voltage supply unit may supply the bias voltage which is below a predetermined reference voltage to the light detection unit.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a diagram illustrating a layered structure inside a radiation detector according to an embodiment of the present invention; and

FIG. 2 is a diagram illustrating a radiation image detector including a radiation detector according to an embodiment of the present invention.

### DETAILED DESCRIPTION OF EMBODIMENTS

Hereinafter, a radiation detector according to an embodiment of the present invention will be described in detail with reference to the accompanying drawings. Thicknesses of lines or sizes of components shown in the figures may be exaggeratedly illustrated for clarity and convenience of description. Further, the terminology described below may be defined by considering a function in the present invention, and may differ according to the intention or custom of a user or an operator. Accordingly, the definitions with respect to the terminology may be determined based on overall content of the present specification.

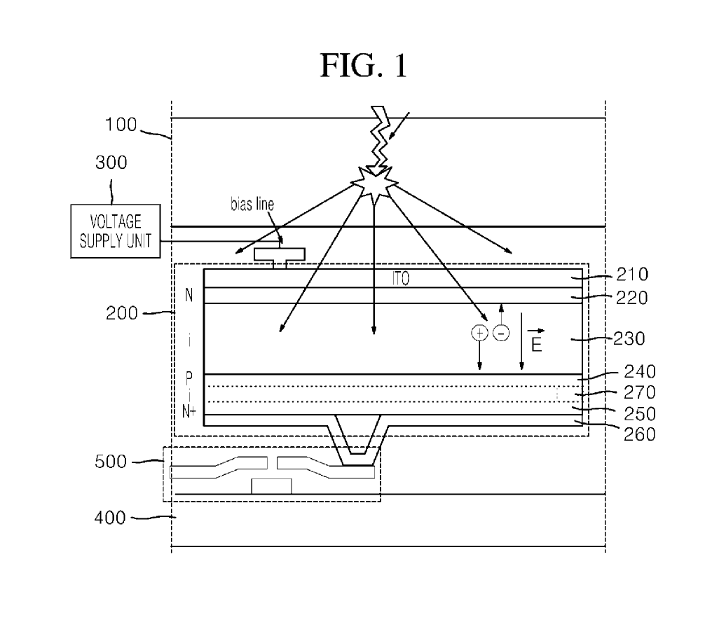

FIG. 1 is a diagram illustrating a layered structure inside a radiation detector according to an embodiment of the present invention.

Referring to FIG. 1 a radiation detector may include a scintillator 100, an light detection unit 200, and a voltage supply unit 300.

The scintillator 100 is an x-ray absorber. It scintillates or emits light upon the absorption of x-ray photons.

The light detection unit 200 includes a plurality of layers optically coupled to the scintillator 100. Upon receiving a bias voltage, the light detection unit 200 generates electron-hole pairs upon the absorption of a light photon from the scintillator 100.

Specifically, in this embodiment the light detection unit 200 consists of a plurality of layers in the following order: an top electrode 210, a first n-type doped layer 220, a first intrinsic layer 230, p-type doped layer 240, a second n-type doped layer 250, and a lower electrode 260 are formed by the processes of thin film vacuum vapor deposition in the reverse order.

In particular, the top electrode 210 is ITO (Indium Tin Oxide) as a transparent electrode formed by vacuum deposition.

Also, the first n-type doped layer 220 is an n-type doped layer with a typical concentration of an n dopant. The second n-type doped layer 250 is an n-plus-type doped layer with a higher concentration of an n dopant.

The first intrinsic layer 230 is deposited between the first n-type doped layer 220 and the p-type doped layer 240 with a balanced density of electron and hole carriers. The second n-type doped layer 250 is deposited between the p-type doped layer 240 and the lower electrode 260.

Particularly, the plurality of n-type doped layers 220 and 250, the first intrinsic layer 230, and the p-type doped layer 240 according to the embodiment of the present invention may be formed to include amorphous silicon.

In the embodiment, the light detection unit 200 may have a high absorption coefficient with respect to visible light and be formed as a thin film by forming the plurality of n-type doped layers 220 and 250, the intrinsic layer 230, and the p-type doped layer 240 which include amorphous silicon.

However, embodiments are not limited thereto, and the plurality of n-type doped layers 220 and 250, the intrinsic layer 230, and the p-type doped layer 240 may be formed to include at least one of various materials such as polycrystalline silicon, crystalline silicon, cadmium selenide, etc.

Specifically, a layered structure of the light detection unit 200 configured as a vacuum deposition structure may have a structure which is layered in a sequence of the lower electrode 260, the second n-type doped layer 250, the p-type doped layer 240, the first intrinsic layer 230, the first n-type doped layer 220, and the top electrode 210, on the substrate 400.

Referring to FIG. 1, specifically, a structure in which the scintillator 100 and the light detection unit 200 are layered on the substrate 400 may have a structure which is layered in a sequence of the lower electrode 260, the second n-type doped layer 250, the p-type doped layer 240, the first intrinsic layer 230, the first n-type doped layer 220, and the top electrode 210 on the substrate 400, and emits light according to absorption of the radiation by the scintillator 100 being stacked on the top electrode 210.

In addition, the top electrode 210 of the light detection unit 200 may receive the bias voltage provided from the voltage supply unit 300.

Further, in order to collect an optical signal detected in the light detection unit 200 included in each of a plurality of pixels, a thin film transistor (TFT) 500 included in each pixel may be connected to the lower electrode 260 of the light detection unit 200.

A detection gain of the light detection unit 200 may be increased by extracting an additional electron from the lower electrode 260.

Hereinafter, a process of detecting light emitted from the scintillator 100 through the light detection unit 200 according to the embodiment of the present invention will be described below in detail.

First, when the radiation is radiated on the radiation detector, the scintillator 100 may absorb the radiation, and emit light. Next, the emitted light may be absorbed into the first intrinsic layer 230, and an electron-hole pair may be formed in the first intrinsic layer 230.

As the bias voltage is supplied from the voltage supply unit 300 to the top electrode 210, an electron formed in the first intrinsic layer 230 may move in the direction of the top electrode 210 and a hole may move in the direction of the p-type doped layer 240.

At this time, since the hole has a lower mobility than the electron, a drift time of the hole drifting from the light detection unit 200 may be relatively longer than that of the electron. Accordingly, while the hole formed in the first intrinsic layer 230 moves into the lower electrode 260, additional electrons extracted from the lower electrode 260 may quickly move into the top electrode 210.

Specifically, since the embodiment according to the present invention described above additionally includes the second n-type doped layer 250, a depletion layer may be formed between the p-type doped layer 240 and the second n-type doped layer 250 due to the supply of the bias voltage.

In addition, when the hole formed in the first intrinsic layer 230 reaches the depletion layer, since electrical balance of the depletion layer is destroyed due to the corresponding hole, an electron may be additionally emitted from the lower electrode 260 connected to a drain of the TFT 500.

Therefore, in the embodiment of the present invention, a photodetection gain (charge gain) according to the incidence of the radiation may increase due to the additional formation of the second n-type doped layer 250.

Specifically, the photodetection gain (charge gain) of the light detection unit 200 according to the embodiment of the present invention may be determined based on the mobilities of the electron and the hole.

That is, since the process in which a new electron is injected continuously proceeds until the hole reaches the lower electrode 260, the photodetection gain may be determined according to the mobility, which is information regarding how quickly the electron and the hole move.

In addition, the photodetection gain of the light detection unit 200 may be determined based on thicknesses of the first intrinsic layer 230 and the depletion layer formed by the p-type doped layer 240 and the second n-type doped layer 250.

That is, since a distance in which the electron or the hole has to move according to thicknesses of the first intrinsic layer 230 and the depletion layer is different, the photodetection gain may be determined according to the thicknesses of the first intrinsic layer 230 and the depletion layer.

Since a factor having an influence on the photodetection gain is not limited thereto, the photodetection gain may be determined by reflecting an additional factor.

The voltage supply unit 300 may be configured to supply the bias voltage needed for an operation of the light detection unit 200, and supply the bias voltage which is below a predetermined reference voltage to the light detection unit 200.

Therefore, in the embodiment of the present invention, the bias voltage that is within a range capable of preventing the generation of excessive dark current may be supplied, and the radiation may be detected using an optimum detection gain by controlling the thicknesses of the first intrinsic layer 230 and the depletion layer.

In addition, the radiation detector according to the embodiment of the present invention may further include a second intrinsic layer 270 formed between the p-type doped layer 240 and the second n-type doped layer 250.

That is, it may be possible to use the depletion layer which is automatically generated by the p-type doped layer 240 and the second n-type doped layer 250. However, it may be also possible to form the second intrinsic layer 270 in the form of an additional intrinsic layer like the first intrinsic layer 230.

Accordingly, since the radiation detector according to the embodiment of the present invention increases the detection gain according to the incidence of the radiation by including the additional second n-type doped layer 250, a clearer radiation image with higher definition may be obtained when detecting a radiation image based on the detection signal of the radiation detector according to the embodiment of the present invention.

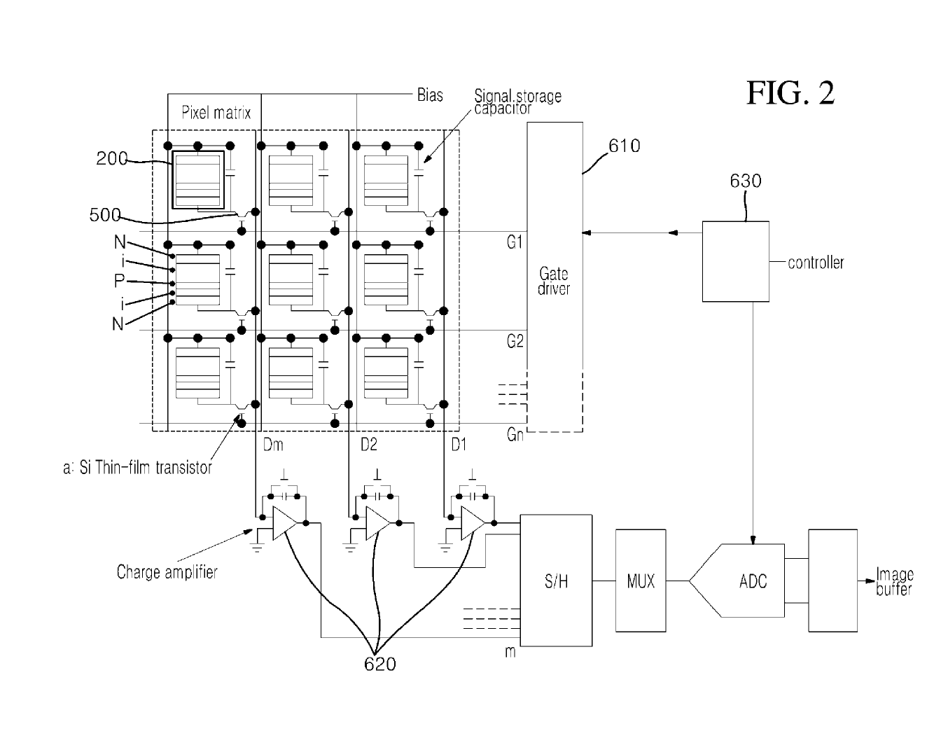

FIG. 2 is a diagram illustrating a radiation image detector including a radiation detector according to an embodiment of the present invention.

Referring to FIG. 2, the radiation detector according to the embodiment of the present invention may be included in each of a plurality of pixels, each pixel may be arranged in an array form, and a TFT 500 of each pixel may be connected to the lower electrode 260 of the light detection unit 200.

A bias line for transferring the bias voltage needed for the operation of the light detection unit 200 may be connected to the top electrode 210 of the light detection unit 200.

Accordingly, an output signal of a gate driver 610 may be controlled under the control of a controller 630, and a signal of the light detection unit 200 detected in each pixel may be selectively input to a charge amplifier 620 according to the output signal of the gate driver 610.

The controller 630 may finally detect the radiation image based on every signal detected in every pixel.

In the embodiment described above, although an example of using the TFT 500, which is frequently used as an image sensor, is described as a construction for transferring the signal of the light detection unit 200, embodiments are not limited thereto and various devices may be selectively used.

As described above, when the radiation detector according to the embodiment of the present invention is used, since the detection gain with respect to the incident radiation is increased, a signal in which a signal to noise ratio (SNR) is improved may be output.

In addition, according to the use of the output signal in which the SNR is improved, a high definition radiation image may be obtained in the radiation image detector.

That is, in the embodiment of the present invention, since a gain of the output signal of each pixel in which the radiation detector is included is increased with respect to the incident of the same radiation, an influence of a noise with respect to the output signal can be reduced.

According to the embodiment of the present invention, the signal to noise ratio may be improved by increasing the amount of charges formed by the incident of the radiation.

Further, the embodiment of the present invention, optimum detection gain needed for each user can be obtained by controlling the charge and the thickness of the intrinsic layer or the depletion layer.

In addition, when detecting the radiation image based on the detection signal of the radiation detector according to the embodiment of the present invention, a radiation image with low noise and high definition can be obtained.

According to the present invention, with a positive bias potential applied to the top electrode, electron-hole pairs are generated upon the absorption of light photons emitted from the scintillation layer.

Under the positive bias electric field, the hole and electron are separated from the pair, and the hole drifts towards the bottom TFT drain electrode while the electron drifts towards the top electrode.

Since the mobility of the hole is lower than the mobility of the electron in amorphous silicon, the drift time of the electron in the first intrinsic layer is shorter than the drift time of the hole.

Also, under a positive bias potential, the depleted layer between the p-doped layer and the second n-doped layer is developed with the depleted layer thickness proportional to the strength of the bias potential.

As the hole drifts to reach this depletion layer due to the positive field nature of the hole in the second depleted layer, the electron is emitted from the bottom TFT drain electrode and drifts towards the top electrode.

As the electron is absorbed by the top electrode, charge imbalance causes another electron to be emitted. This process is continued until the slow drifting hole reaches the bottom drain electrode.

Since the mobility of the hole is several times smaller than the mobility of the electron in amorphous silicon, each hole will cause more than one electron to be emitted from the drain electrode, and this is represented as a gain factor in the signal received by the TFT.

According to the present invention, the signal to noise ratio of a radiation detection signal can be increased by increasing the amount of charges formed by the incidence of the radiation.

In addition, in the present invention, an optimum detection gain needed for each user can be obtained by controlling the charge mobilities, the thickness of an intrinsic layer or a depletion layer, and the magnitude of the bias potential.

Further, when detecting a radiation image based on the detection signal of the radiation detector according to the present invention, a clearer radiation image with higher definition in which the influence of a noise is reduced can be obtained.

Although the present invention has been described with reference to the embodiments shown in drawings, those skilled in the art will readily appreciate that many modifications are possible without materially departing from the novel teachings and advantages. Accordingly, all such modifications are intended to be included within the scope of this inventive concept as defined in the claims.

What is claimed is:

1. A radiation detector comprising:
a scintillator to emit light upon absorption of radiation; and
a light detection unit, wherein the light detection unit comprises an top electrode, a plurality of n-type doped layers, a first intrinsic layer, a p-type doped layer, and a lower electrode.

2. The radiation detector of claim 1, wherein the plurality of n-type doped layers comprise a first n-type doped layer and a second n-type doped layer, the first n-type doped layer is formed between the top electrode and the first intrinsic layer, and the second n-type doped layer is formed between the p-type doped layer and the lower electrode.

3. The radiation detector of claim 1, wherein the second n-type doped layer is an n-plus-type doped layer.

4. The radiation detector of claim 2, wherein the top electrode, the plurality of n-type doped layers, the first intrinsic layer, the p-type doped layer, and the lower electrode are layered in a sequence of the lower electrode, the second n-type doped layer, the p-type doped layer, the intrinsic layer, the first n-type doped layer, and the top electrode on the substrate.

5. The radiation detector of claim 2, further comprising a second intrinsic layer formed between the p-type doped layer and the second n-type doped layer.

6. The radiation detector of claim 1, wherein the top electrode is formed to include Indium Tin Oxide (ITO).

7. The radiation detector of claim 1, further comprising:
a voltage supply unit configured to supply a bias voltage needed for an operation of the light detection unit.
